(19) United States
(12) Patent Application Publication
(10) Pub. No.: US 2002/0091873 A1
(43) Pub. Date: Jul. 11, 2002

(54) Method for intercepting callback functions

(76) Inventor: Chun-Hua Tseng, Chiayi (TW)

Correspondence Address: J.C. Patents, Inc., Suite 250, 4 Venture, Irvine, CA, 92618, US

(21) Appl. No.: 09/948,869

(22) Filed: Sep. 7, 2001

(30) Foreign Application Priority Data
Jan. 9, 2001 (TW) 90100426

(51) Int. Cl. G06F 13/10; G06F 9/46

(52) U.S. Cl. 709/321; 709/318

(57) ABSTRACT

A method of transmitting messages between two drivers by using a filter driver is provided. The method includes sending a request from the first driver to the filter driver; mending the request by using the filter driver; sending the mended request from the filter driver to a second driver; executing the requested task by using the second driver; returning the status of the requested task from the second driver to the filter driver; upon the happening of an expected event, the call for the callback function from the second driver, mending the returned status of the requested task by using the filter driver; and sending the mended status of the requested task to the first driver from the filter driver.

### CROSS-REFERENCE TO RELATED APPLICATION

This application claims the priority benefit of Taiwan application Ser. No. 90100426, filed Jan. 9, 2001.

### BACKGROUND OF THE INVENTION

1. Field of Invention

The present invention relates to a method of transmitting data between two drivers. More particularly, the present invention relates to a method for intercepting callback functions between two drivers through a filter driver.

2. Description of Related Art

As Microsoft@ Windows@, drivers are loaded in memory in a layering fashion. The communications, requests, between drivers are carried by IO request packages (IRP). Upon receipt of an IRP, a driver first validates the request and then performs the requested task. If the driver is not the destined one, the IRP bypasses the current driver and moves to the driver loaded on the next layer, or calls the driver on the next layer.

However, while an IRP is transmitted between two drivers, if there is any change or replacement made on either driver, the change of default values might cause incompatibility problem between interfaces of two drivers. The incompatibility between interfaces of two drivers occurs more often when the changed or replaced driver is relating to some hardware. Conventional, a filter driver is added between two drivers to resolve the incompatibility.

The flowchart of FIG. 1 shows a conventional method of transmitting an IRP between two drivers through a filter driver. While a request is going to be transmitted from a first driver to a second driver, the first driver passes the request to a filter driver instead of directly passing the request to the second driver. Then, the filter driver passes the request to the second driver. As shown in FIG. 1, Step 910, the first driver calls the filter driver and passes the request thereto. The next, Step 920, the filter driver may firstly revise the request due to some follow-up proceeding. And then, as in Step 930, the filter driver passes the request downward to the second driver, that is, calls the second driver. Next in Step 940, the second driver, the destination for the request, performs the task asked by the request. And then, as in Steps 950 and 960, the second driver firstly returns the status of the requested task to the filter driver, and then, the status of the requested task is passed to the first driver.

The foregoing conventional method uses an interrupt signal to confirm the status of the requested task for efficiency and multi-tasking purpose. However, the transmission paths of the interrupt signal and the IRP are different. Step 110 of FIG. 1, after the requested task is finished, the second driver sends an interrupt directly to the first driver to call a callback function of the first driver. Because the interrupt does not go through the similar revising process performed by the filter driver as the request does, sending the interrupt directly to the first driver may cause incompatibility problem. In addition, the second driver might send an interrupt to call the first driver at any time, either before or after the status of requested task is returned back to the first driver, so the calling for callback function from the second driver might cause undesired overwriting or updating of data. Therefore, of execution errors occur.

### SUMMARY OF THE INVENTION

Accordingly, one object of the present invention is to provide a method of intercepting callback function that mending the handling of callback function to prevent the occurrence of known problems.

A second object of this invention is to provide a method of transmitting messages between two drivers by using a filter driver to prevent the occurrence of known problems.

To achieve these and other advantages and in accordance with the purpose of the invention, as embodied and broadly described herein, the invention provides a method of transmitting messages between two drivers by using a filter driver. The method of this invention includes sending a request from the first driver to the filter driver; mending the request by using the filter driver; sending the mended request from the filter driver to a second driver; executing the requested task by using the second driver; returning the status of the requested task from the second driver to the filter driver; upon the happening of an expected event, the call for the callback function from the second driver, mending the returned status of the requested task by using the filter driver; and sending the mended status of the requested task to the first driver from the filter driver.

The invention provides another method of transmitting messages between drivers by using a filter driver including sending a request from a first driver to the filter driver; mending the request by using the filter driver; sending the mended request from the filter driver to a second driver; executing the requested task by using the second driver; returning the status of the requested task from the second driver to the filter driver; returning the status to the first driver; sending a call for callback function to the filter driver; and sending the callback function to the second driver from the filter driver.

In this invention, another method of transmitting messages between two drivers by using a filter driver includes sending a request from the filter driver; mending the request by using the filter driver; sending the mended request from the filter driver to a second driver; executing the requested task by using the second driver; returning the status of the requested task from the second driver to the filter driver; returning the status of the requested task to the first driver; sending a call for callback function from the second driver to the filter driver; mending the call for callback function by using the filter driver; sending the mended call for callback function to the first driver from the filter driver.

The method of the invention uses a filter driver as a conversion medium between two drivers to prevent the occurrence of incompatibility happening at the interface of the drivers. The call for callback function from the second driver is driven by an interrupt request that does not occur at a particular time; therefore, the steps in the methods of the invention are permutable.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention. In the drawings,

FIG. 1 is a flowchart showing a conventional method of transmitting messages between two drivers;

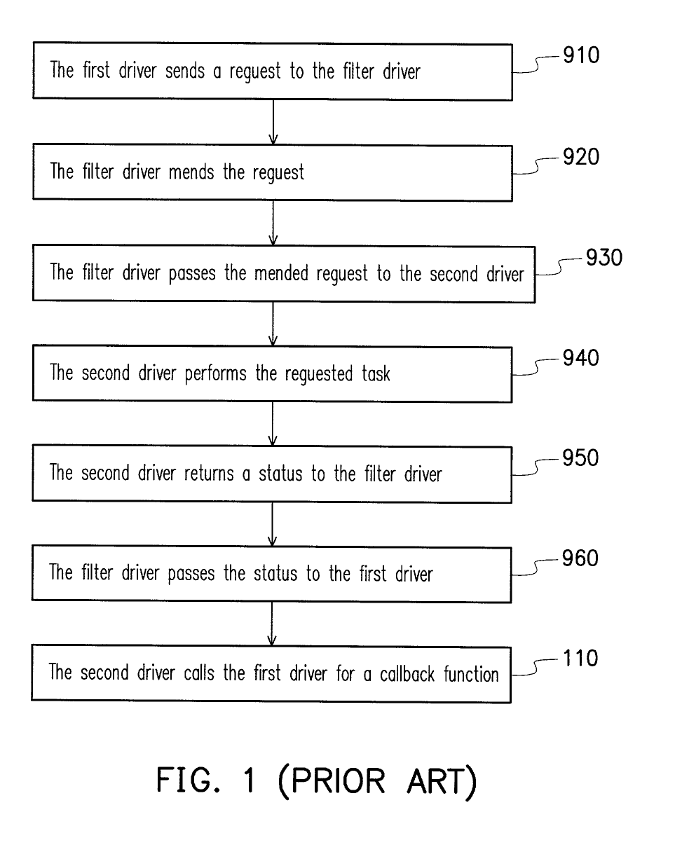

FIG. 2A is a schematic block diagram showing the method of transmitting messages between two drivers by using a filter driver according to the first embodiment of this invention;

FIG. 2B is a flowchart showing the method of transmitting messages between two drivers by using a filter driver according to the first embodiment of this invention;

FIG. 3A is a schematic block diagram showing the method of transmitting messages between two drivers by using a filter driver according to the second embodiment of this invention;

FIG. 3B is a flowchart showing the method of transmitting messages between two drivers by using a filter driver according to the second embodiment of this invention;

FIG. 4A is a schematic block diagram showing the method of transmitting messages between two drivers by using a filter driver according to the third embodiment of this invention;

FIG. 4B is a flowchart showing the method of transmitting messages between two drivers by using a filter driver according to the third embodiment of this invention;

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

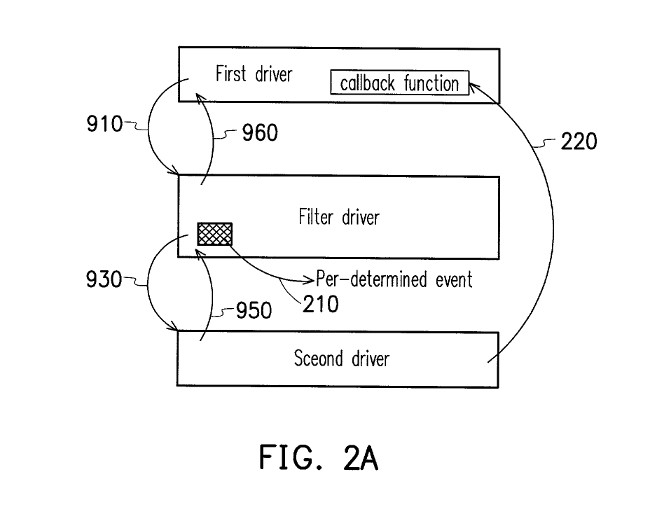

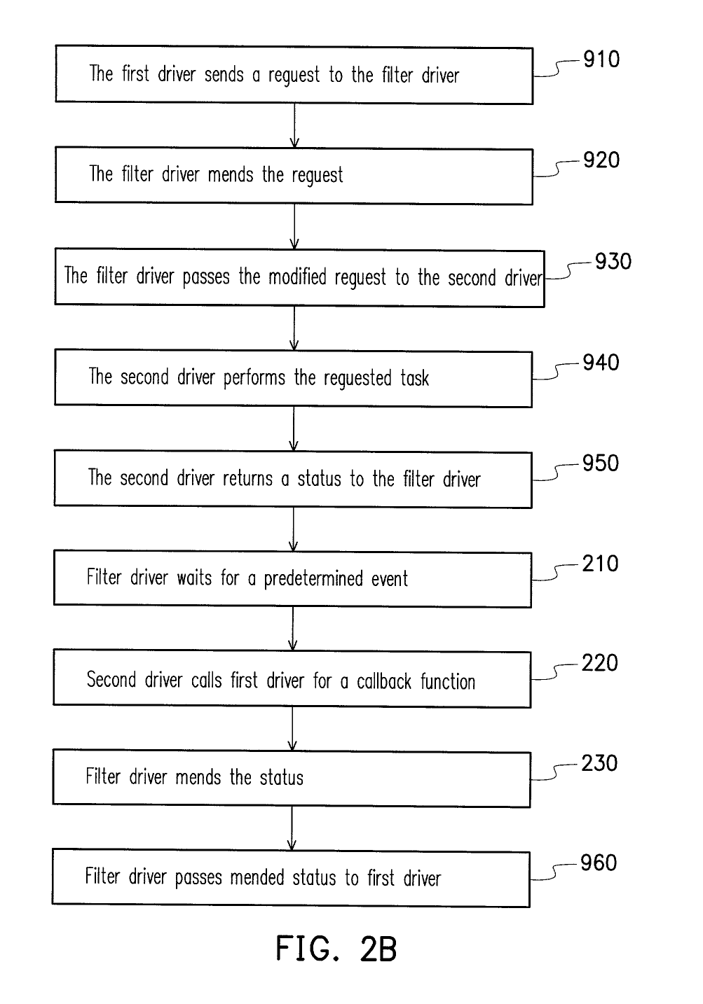

The first preferred embodiment of this invention for a method of transmitting messages between two drivers by using a filter driver is shown in FIGS. 2A and 2B.

In FIG. 2B, Step 910, the first driver calls the filter driver and passes the request thereto. The next, Step 920, the filter driver may firstly revise or mend the request due to some follow-up proceeding. And then, as in Step 930, the filter driver calls the second driver and passes the request downward to the second driver. Next in Step 940, the second driver, the destination for the request, performs the task asked by the request. And then, as in Step 950, the second driver returns the status of the requested task to the filter driver. Step 210, after receiving the status of the requested task, the filter driver is on standby state unless an expected event occurs, wherein the event includes a call for callback function from the second driver, or a predetermined period of time. In Step 220, the second driver sends a call for callback function to the first driver, wherein the call for callback function is driven by an interrupt. After the occurrence of Step 220, the filter driver similarly revises or mends the returned status of requested task, Step 230, and then sends it to the first driver, Step 960.

Generally, the returned status of the requested task from the second driver is a confirmation that the second driver has received the request. Therefore, if the Status of the requested task from the second driver arrives at the first driver before the arrival of the interrupt from the second driver for a callback function, undesired data overwriting or update will occur.

In the method in the first embodiment of the invention, the filter driver does not revise or mend the returned status of the requested task, Step 230, until the second driver sends an interrupt to the first driver for requesting the callback function, Step 220. After revising or mending the returned status, the filter driver then passes the returned status to the first driver, Step 960.

Alternately, instead of waiting for the interrupt signal from the second driver, Step 960 can also be triggered by the end of a predetermined period of time. After waiting for a predetermined period of time starting from the end of Step 950, the filter driver revises or mends the returned status, Step 230, and then, Step 960, passes the returned status to the first driver.

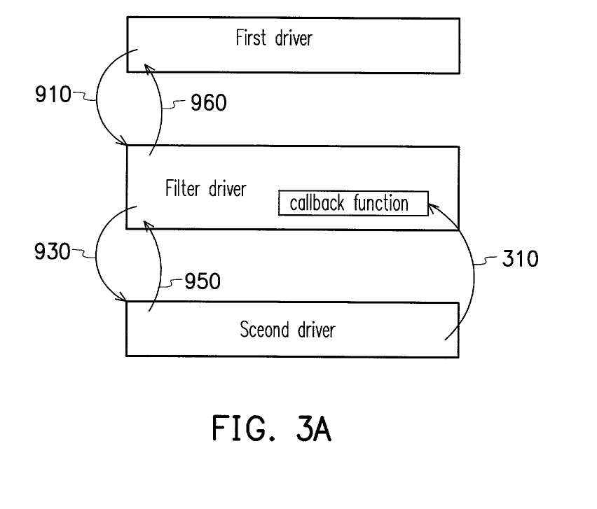

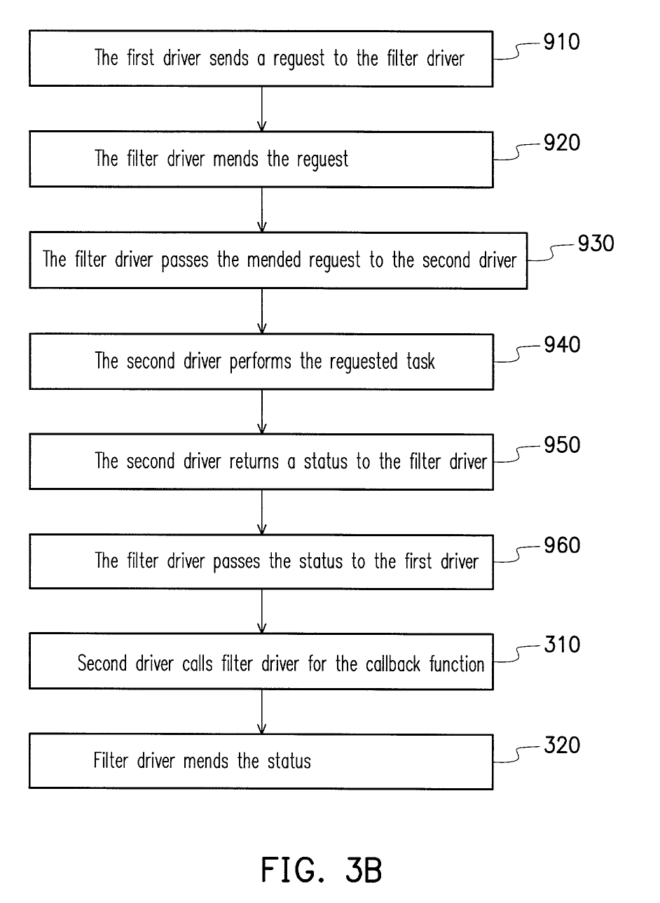

Another preferred embodiment of the invention is shown in FIGS. 3A and 3B.

The method according to the second preferred embodiment of the invention includes steps, Step 910 to Step 950, which are the same as described in the previous preferred embodiment of the invention. In FIG. 3B, Step 910, the first driver calls the filter driver and passes the request thereto. The next, Step 920, the filter driver may firstly revise or mend the request due to some follow-up proceeding. And then, as in Step 930, the filter driver calls the second driver and passes the request downward to the second driver. Next in Step 940, the second driver, the destination for the request, performs the task asked by the request. And then, as in Step 950, the second driver returns the status of the requested task to the filter driver.

After the second driver returns the status of the requested task to the filter driver, Step 950, the filter driver then passes the status of the requested task to the first driver, Step 960. Then, Step 310, the second driver calls the filter driver for the callback function through an interrupt signal, wherein the call back function is the same as the one in the first driver of the above-mentioned conventional method. And the next, Step 320, in response to the request from the second driver, the filter driver performs an all-back process.

In this embodiment of the invention, the second driver calls the filter driver instead of calling the first driver for the callback function. Therefore, the status of the requested task is returned to the first driver immediately without waiting for the occurrence of a certain event or a predetermined period of time. The second embodiment of the invention does not only eliminate undesired data overwriting problem and incompatibility problem of the conventional method, it also skips the step of waiting for a predetermined period of time of the first embodiment of the invention.

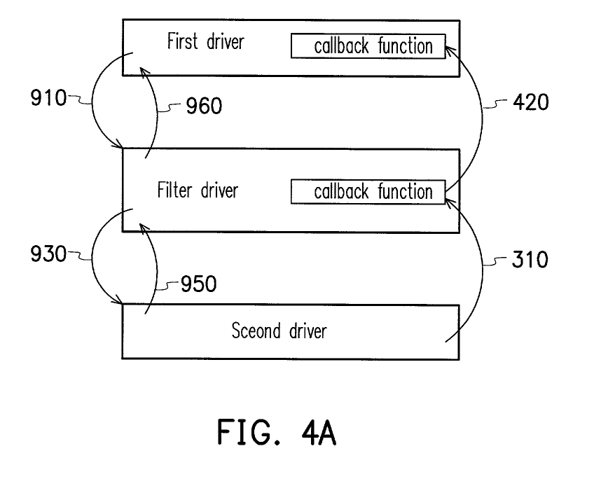

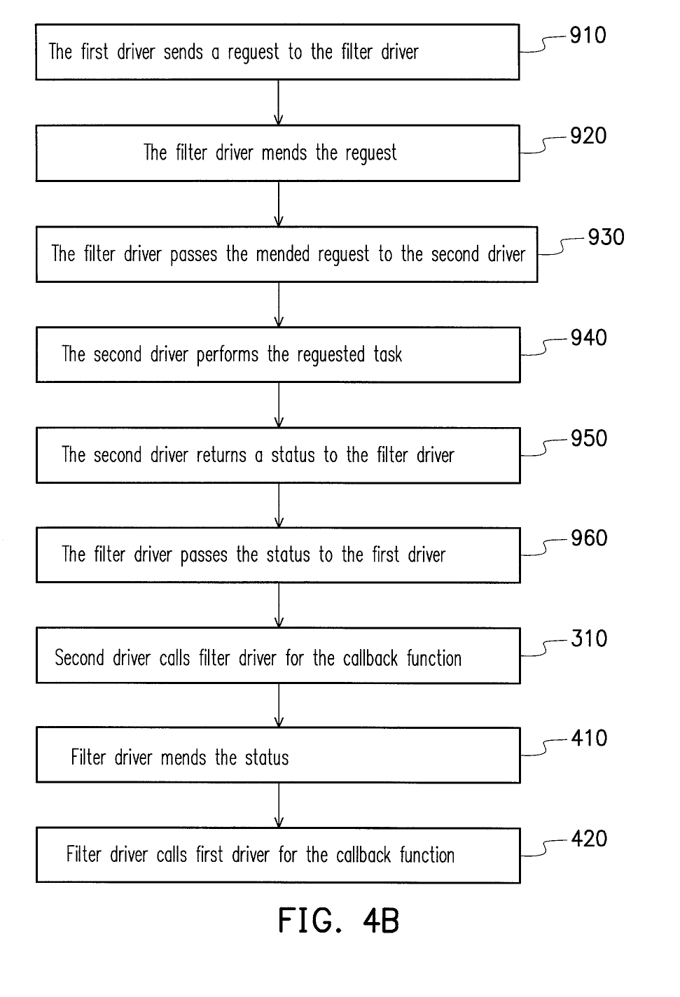

Another preferred embodiment of the invention is shown in FIGS. 4A and 4B.

The method according to the third preferred embodiment of the invention includes steps, Step 910 to Step 310, which are the same as described in the second preferred embodiment of the invention. In FIG. 4B, Step 910, the first driver calls the filter driver and passes the request thereto. The next, Step 920, the filter driver may firstly revise or mend the request due to some follow-up proceeding. And then, as in Step 930, the filter driver calls the second driver and passes the request downward to the second driver. Next in Step 940, the second driver, the destination for the request, performs the task asked by the request. And then, as in Step 950, the second driver returns the status of the requested task to the filter driver. After the second driver returns the status of the requested task to the filter driver, Step 950, the filter driver then passes the status of the requested task to the first driver, Step 960. Then, Step 310, the second driver calls the filter driver for the callback function through an interrupt signal, wherein the call back function is the same as the one in the first driver of the abovementioned conventional method.

Afterward, Step 410,in response to the request from the second driver, the filter driver performs a callback process. And then, Step 420, the filter driver calls the first driver for the callback function.

In Step 410, in response to the request from the second driver, the filter driver checks and adjusts the interfaces of the first or/and second drivers, if there is some variation, that is, rectifies the incompatibility at the interface between the first and second drivers. On the other hand, when the filter driver calls the first driver for the callback function, the callback function of the first driver responds but does not perform the check and adjusting task mentioned above.

Therefore, in the third embodiment of the invention, there will be not undesired data overwriting between the callback function of the filter driver and the returned status of the requested task from the second driver to the first driver. In addition, there will be not waiting in this method, so it is more efficient.

In all three preferred embodiments of the invention, it is known that the calling for callback function from the second driver is driven by an interrupt signal, which may occur at any time. Therefore, the steps of the invention are permutable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of transmitting a message between a first driver and a second driver by using a filter driver, comprising steps of:
returning to said filter driver from said second driver;
waiting for an event at said filter driver;
calling callback function in said first driver from said second driver;
executing a return mending by said filter driver; and
returning to said first driver from said filter driver.

2. The method of claim 1, wherein said event is a predetermined period of time.

3. The method of claim 1, wherein said event is an occurrence of an interrupt signal.

4. The method of claim 1, wherein said event is occurred after executing said callback function.

5. The method of claim 1, wherein said step of calling callback function in said first driver from said second drive is following after said occurrence of an interrupt signal generated by said second driver.

6. The method of claim 1 further comprises steps of:
calling said filter driver from said first driver;
executing a call mending by said filter driver;
calling said second driver from said filter driver; and
executing a requested task by said second driver.

7. A method of transmitting a message between a first driver and a second driver by using a filter driver, comprising steps of:
returning to said filter drier from said second driver;
returning to said first driver from said filter driver;
calling callback function in said filter driver from said second driver; and
executing a callback process by said filter driver.

8. The method of claim 7, wherein said callback process further comprises interchangeable with a callback function in said first driver.

9. The method of claim 7, wherein said step of calling callback function in said filter driver from said second driver is following after said occurrence of an interrupt signal generated by said second driver.

10. The method of claim 7 further comprises steps of:
calling said filter driver from said first driver;
executing a mending process by said filter driver;
calling said second driver from said filter driver; and
executing a requested task by said second driver.

11. A method of transmitting a message between a first driver and a second driver by using a filter driver, comprising steps of:
returning to said filter driver from said second driver;
returning to said first driver from said filter driver;
calling callback function in said filter driver from said second driver;
executing a return mending by said filter driver; and
calling callback function in said first driver from said filter driver.

12. The method of claim 11, wherein said return mending comprises mending an interface between said first driver and said second driver.

13. The method of claim 11, wherein said step of calling callback function in said filter driver from said second driver is following after said occurrence of an interrupt signal generated by said second driver.

14. The method of claim 11 further comprises steps of:
calling said filter driver from said first driver;
executing a call mending by said filter driver;
calling said second driver from said filter driver; and
executing a requested task by said second driver.
